(19) United States
(12) Patent Application Publication
(10) Pub. No.: US 2018/0010958 A1
(43) Pub. Date: Jan. 11, 2018

(54) FIBER OPTIC SENSOR, MANUFACTURING METHOD THEREOF, AND VIBROSCOPE USING SAME

(71) Applicant: Young Tae KIM, Icheon-si (KR)

(72) Inventor: Young Tae KIM, Icheon-si (KR)

(21) Appl. No.: 15/545,293

(22) PCT Filed: Apr. 5, 2016
(86) PCT No.: PCT/KR2016/003495

§ 371 Date: Jul. 20, 2017

(30) Foreign Application Priority Data
Apr. 8, 2015 (KR) 10-2015-0049590

(51) Int. Cl. G01H 9/00; G02B 6/02; G02B 6/42; G02B 6/25

(52) U.S. Cl. CPC G01H 9/004; G02B 6/4239; G02B 6/02209; G02B 6/25

(57) ABSTRACT

The present invention relates to a fiber optic sensor, a method of manufacturing the same, and a vibroscope using the same. A fiber optic sensor according to an embodiment of the present invention includes: an optical cable; an optical fiber taken out of the optical cable and provided with a fiber Bragg grating (FBG); a mold housing as a case into or to which the optical cable and the optical fiber are partially inserted and fixed, the mold housing including an optical cable accommodation groove to accommodate the optical cable, an optical fiber accommodation hole extending from the optical cable accommodation groove to accommodate the optical fiber, and a coating agent introduction hole communicated with the optical fiber accommodation hole so as to allow fluid to flow therebetween from an outer side of the mold housing so that a liquid-type coating agent permeates via the optical fiber accommodation hole; and a coating layer filling the optical fiber accommodation hole and the coating agent introduction hole and formed on an outer circumference of the optical fiber including the FBG and a surface of the mold housing.

### TECHNICAL FIELD

The present invention relates to a vibroscope for sensing the vibration of a precision machine, equipment, or the like, and more particularly, to a fiber optic sensor for sensing vibration using fiber Bragg grating (FBG) characteristics, a method of manufacturing the same, and a vibroscope using the fiber optic sensor.

### BACKGROUND ART

Generally, vibroscopes for sensing the vibration of machines are mechanical instruments using a piezo or vibration element, and thus malfunction due to limited space utilization, ambient environmental factors (electromagnetic waves and electric noise), and the like, and also have limited volume and weight, resulting in difficulty in installation on high-speed, high-precision mechanical equipment.

Meanwhile, research into and development of a fiber Bragg grating (FBG) sensor method using optical fibers have recently been conducted as an alternative.

An FBG sensor is a sensor that uses light reflection/refraction/diffraction/transmission, and the like by transmitting light through a fiber optic sensor, and includes a laser light source with a variable wavelength, a probe consisting of a circulator, a fiber Bragg grating, and a reflection plate, and a light receiving unit for receiving light having been reflected and returned.

FIG. 1 illustrates wavelength spectra of a light source and a fiber Bragg grating. FIG. 2 is a diagram for explaining a principle of vibration sensing of a fiber optic sensor.

As illustrated in FIG. 2, when a probe vibrates in a transverse direction, a fiber Bragg grating is bent, and the Bragg wavelength is shifted in proportion to bending and the magnitude of light reflected from the fiber Bragg grating will be varied because a central wavelength of a light source is positioned at an inclined portion of the wavelength spectrum of the Bragg grating, as illustrated in FIG. 2.

In an experiment, when stimulation is applied to a probe, the central wavelength of the Bragg grating is shifted. At this time, to sense vibration, as illustrated in FIG. 2, the wavelength of the light source has to be shifted so that the Bragg wavelength is positioned in an inclined portion of the Bragg wavelength, and such shifting of the wavelength of the light source occurs in proportion to an operating current and set temperature of a laser diode.

Such a fiber optic sensor has a unique wavelength value and is an excellent physical quantity measurement device that has been replacing existing electric gauges due to excellent physical characteristics, such as not being affected by electromagnetic waves, and the like, and applications thereof are currently expanding rapidly.

A fiber optic sensor has a very small diameter, i.e., about 125 μm, relative to very high tensile force per unit area, and thus may be easily broken by external impact. Accordingly, when the fiber optic sensor is attached to an object to be measured, very delicate operation is required.

In addition, to measure accurate values, a fiber optic sensor has to be installed in a state of being tightly strained so as to have an appropriate tensile force. However, a suitable housing for fiber optic sensors is not conventionally present and thus there are difficulties in terms of construction such as setting values directly by a professional.

Conventionally, such a fiber optic sensor is installed by being directly attached to an object to be measured using an adhesive, or is fabricated into a fixed piece having a certain shape by a user, and is exposed to a variety of external factors, for example, external environmental factors such as rain, wind, temperature, and the like or external impact such as insects, animals, or the like.

Thus, the fiber optic sensor has an unstable signal, measures incorrect modification values, and causes physical reaction with an optical fiber due to condensation of moisture contained in air due to a temperature difference, whereby physical properties thereof deteriorate, and, in severe cases, optical fiber may break due to cracks therein. Accordingly, there are conventionally many difficulties in always inspecting precision mechanical equipment and maintaining and repairing measurement systems.

Prior art patent document—(Patent Document 1) Korean Patent Application Publication No. 10-2012-0004817 (published on Jan. 13, 2012)

### DISCLOSURE

### Technical Problem

Therefore, the present invention has been made in view of the above problems, and it is one object of the present invention to provide a fiber optic sensor, a method of manufacturing the same, and a vibroscope using the fiber optic sensor that may substantially compensate for problems occurring due to limitations and disadvantages of the prior art.

It is another object of the present invention to provide a fiber optic sensor that may minimize an effect due to external environmental factors and enables stable device realization, a method of manufacturing the same, and a vibroscope using the fiber optic sensor.

It is yet another object of the present invention to provide a fiber optic sensor, a method of manufacturing the same, and a vibroscope using the fiber optic sensor.

### Technical Solution

In accordance with one aspect of the present invention, provided is a fiber optic sensor including: an optical cable; an optical fiber taken out of the optical cable and provided with a fiber Bragg grating (FBG); a mold housing as a case into or to which the optical cable and the optical fiber are partially inserted and fixed, the mold housing including an optical cable accommodation groove to accommodate the optical cable, an optical fiber accommodation hole extending from the optical cable accommodation groove to accommodate the optical fiber, and a coating agent introduction hole communicated with the optical fiber accommodation hole so as to allow fluid to flow therebetween from an outer side of the mold housing so that a liquid-type coating agent permeates via the optical fiber accommodation hole; and a coating layer filling the optical fiber accommodation hole and the coating agent introduction hole and formed on an outer circumference of the optical fiber including the FBG and a surface of the mold housing.

In the fiber optic sensor according to an embodiment of the present invention, the optical fiber may be provided with a single FBG to reflect a single wavelength.

In the fiber optic sensor according to an embodiment of the present invention, the mold housing may be provided at an outer side of the optical cable accommodation groove and may further include a fixing part having a thread.

In accordance with another aspect of the present invention, provided is a vibroscope using a fiber optic sensor, including: a light source to emit light with a predetermined wavelength; a fiber optic sensor including an FBG, selectively reflecting light with a particular wavelength (Bragg wavelength), and transmitting all other wavelengths; a signal processing unit to calculate, from a peak point of reflected light reflected from the fiber optic sensor and light intensity data, a wavelength of the reflected light and to calculate a variation of vibration generated from the fiber optic sensor from the calculated wavelength value and calculate a sensed vibration value therefrom; and a circulator to supply light emitted from the light source to the optical fiber sensor and supply light reflected by the fiber optic sensor to the signal processing unit.

In the vibroscope using a fiber optic sensor according to an embodiment of the present invention, the fiber optic sensor may include: an optical cable; an optical fiber taken out of the optical cable and provided with a fiber Bragg grating (FBG); a mold housing as a case into or to which the optical cable and the optical fiber are partially inserted and fixed, the mold housing including an optical cable accommodation groove to accommodate the optical cable, an optical fiber accommodation hole extending from the optical cable accommodation groove to accommodate the optical fiber, and a coating agent introduction hole communicated with the optical fiber accommodation hole so as to allow fluid to flow therebetween from an outer side of the mold housing so that a liquid-type coating agent permeates via the optical fiber accommodation hole; and a coating layer filling the optical fiber accommodation hole and the coating agent introduction hole and formed on an outer circumference of the optical fiber including the FBG and a surface of the mold housing.

In accordance with another aspect of the present invention, provided is a method of manufacturing a fiber optic sensor, including: inserting and fixing an optical cable provided with an optical fiber taken out thereof into and to a mold housing to expose an FBG; assembling the mold housing with the optical fiber inserted thereinto with a shaping mold by alignment so that the optical fiber penetrates a central hole positioned in an end portion of one side of the shaping mold; introducing a coating agent via a coating agent inlet positioned at a side wall of another side of the shaping mold and curing the coating agent for a certain period of time; separating the mold housing from the shaping mold after the curing is completed; and adjusting a length of the optical fiber by cutting the optical fiber.

In the method of manufacturing a fiber optic sensor according to an embodiment of the present invention, the coating agent may consist of a material including a platinum catalyst and silicon.

### Advantageous Effects

As is apparent from the fore-going description, the present invention advantageously provides a fiber optic sensor, a method of manufacturing the same, and a vibroscope using the fiber optic sensor, in which a fiber optic sensor is inserted into a mold housing and a coating layer is formed on a surface thereof, whereby installation limitations due to the structure of mechanical equipment at which the fiber optic sensor is installed or external environmental impact can be minimized, and the fiber optic sensor and the vibroscope can be easily installed.

In addition, a specific FBG fiber optic sensor is selectively used according to frequency band generated when inspecting vibration of mechanical equipment installed, thus enabling precise sensing.

### DESCRIPTION OF DRAWINGS

FIG. 1 illustrates wavelength spectra of a light source and a fiber Bragg grating.

FIG. 2 is a diagram for explaining a principle of vibration sensing of a fiber optic sensor.

FIG. 3 is a diagram illustrating a structure of a vibroscope using a fiber optic sensor according to an embodiment of the present invention.

FIG. 4 is a view illustrating a structure of a fiber optic sensor according to an embodiment of the present invention.

FIGS. 5A to 5C are views illustrating a structure of a mold housing, according to an embodiment of the present invention.

FIG. 6 is a flowchart for explaining a method of manufacturing a fiber optic sensor, according to an embodiment of the present invention.

FIGS. 7A to 7E are views particularly illustrating each process of FIG. 6.

FIG. 8 is an actual image of a fiber optic sensor manufactured according to an embodiment of the present invention.

FIGS. 9 and 10 illustrate comparison results of light source setting conditions and final output signal wavelengths between a fiber optic sensor provided with a coating layer according to an embodiment of the present invention and a conventional fiber optic sensor not including a coating layer.

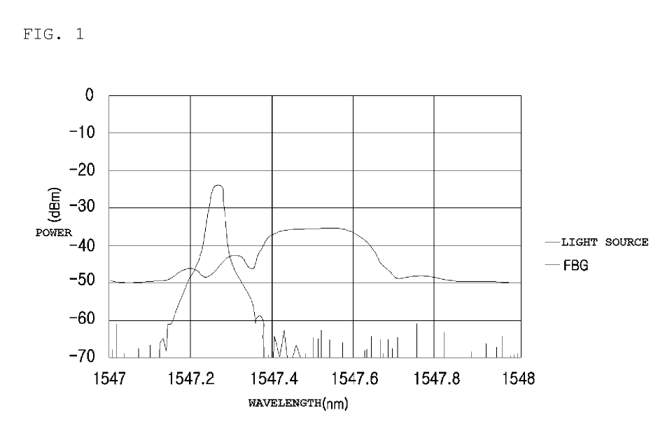

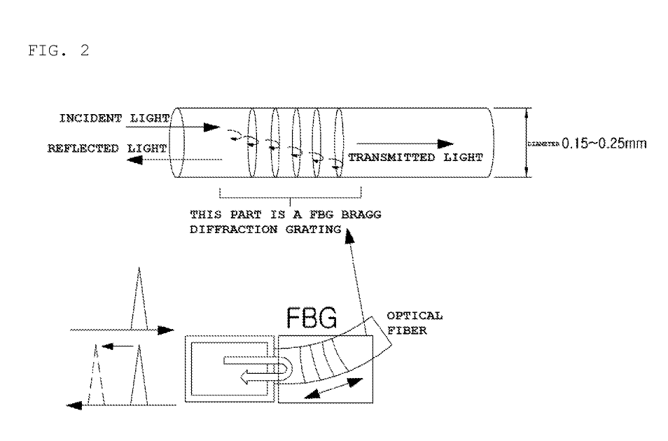

### BEST MODE

Hereinafter, embodiments of the present invention will be described in detail with reference to the accompanying drawings.

In description of the present invention, detailed description of related functions or configurations in the art will be omitted when it is deemed that they may unnecessarily obscure the essence of the present invention. In addition, terms described below are defined in consideration of function of the present invention and may vary according to intents, precedents, or the like of users or operators. Thus, these terms must be defined based on the contents throughout the present specification.

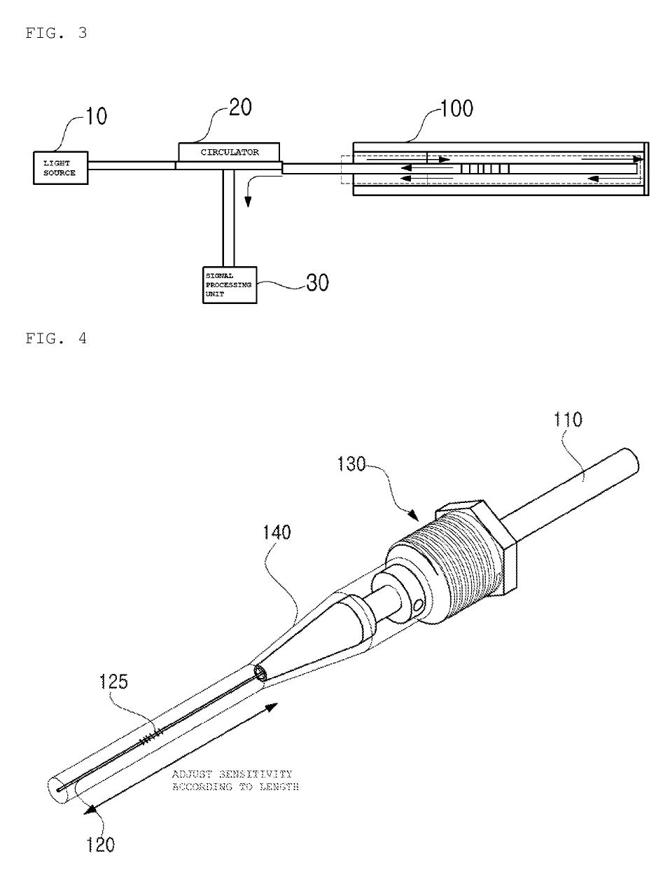

FIG. 3 is a diagram illustrating a structure of a vibroscope using a fiber optic sensor 100 according to an embodiment of the present invention.

Referring to FIG. 3, the vibroscope according to the present embodiment includes a light source 10, a circulator 20, the fiber optic sensor 100, and a signal processing unit 30.

The light source 10 emits light with a predetermined wavelength and may be embodied as a laser diode, or the like.

The circulator 20 supplies light emitted from the light source 10 to the fiber optic sensor 100, and supplies light reflected by the fiber optic sensor 100 to the signal processing unit 30.

The fiber optic sensor 100 includes a fiber Bragg grating (FGB) obtained by creating a certain periodic variation in the refractive index of a core part of optical fiber, and selectively reflects particular wavelengths (Bragg wavelength) of light and transmits all other wavelengths. A structure of the fiber optic sensor 100 will be described below in detail.

The signal processing unit 30 includes a photo detector equipped with a photodiode, and allows reflected light with a particular wavelength reflected from the fiber optic sensor 100 to be transmitted to the photodiode. The photodiode measures and outputs the intensity of the reflected light incident thereon, and calculates a peak point of the reflected light and the intensity of light at the peak point through a differentiator and a comparator. The signal processing unit 30 calculates, from the calculated peak point of the reflected light and the calculated light intensity data, a wavelength of the reflected light. Since the wavelength of reflected light varies according to a physical vibration variation, a variation of vibration generated from the fiber optic sensor 100 is calculated from the calculated wavelength value, and a sensed vibration value may be accurately calculated therefrom.

FIG. 4 is a view illustrating a structure of the fiber optic sensor 100 according to an embodiment of the present invention.

Referring to FIG. 4, the fiber optic sensor 100 according to the present embodiment includes an optical cable 110, an optical fiber 120 taken out of the optical cable and provided with a Bragg grating 125, a mold housing 130, and a coating layer 140.

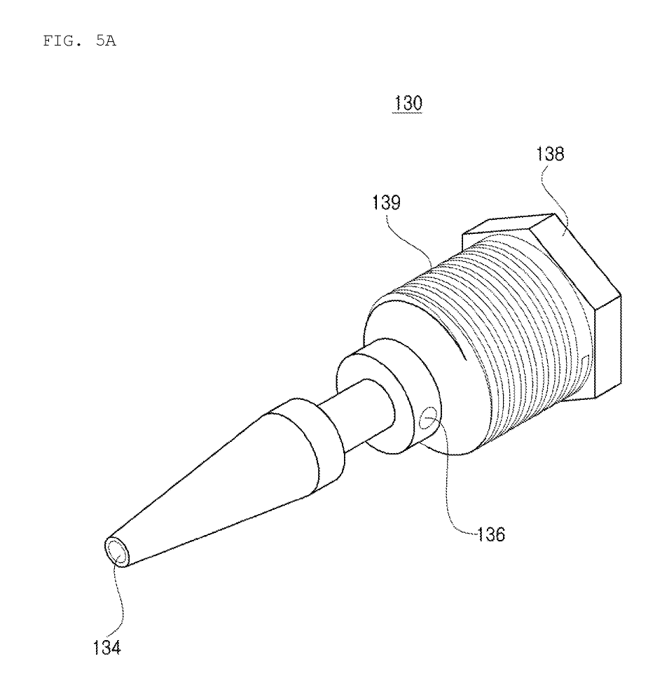

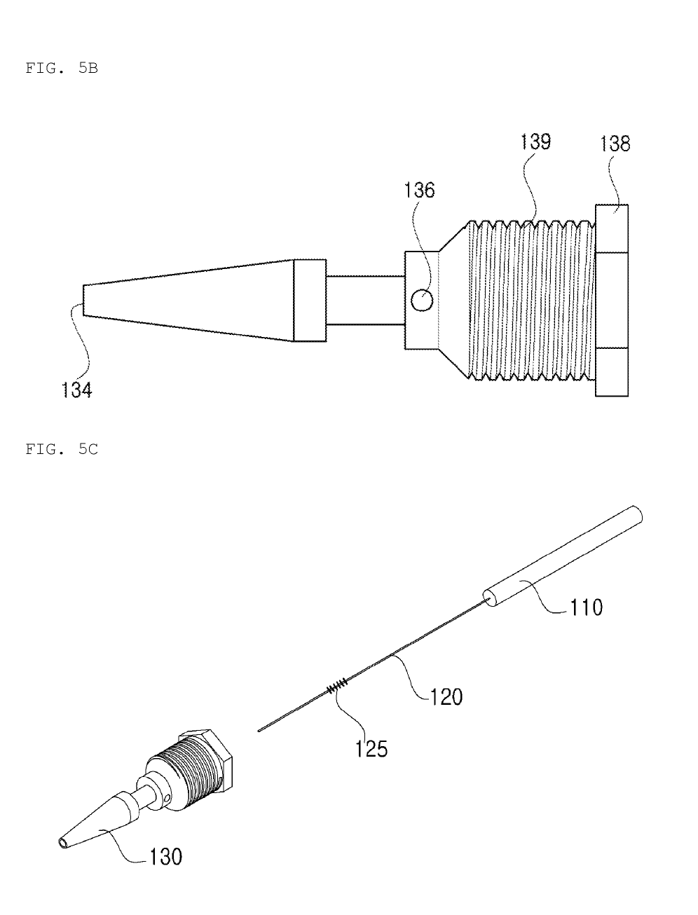

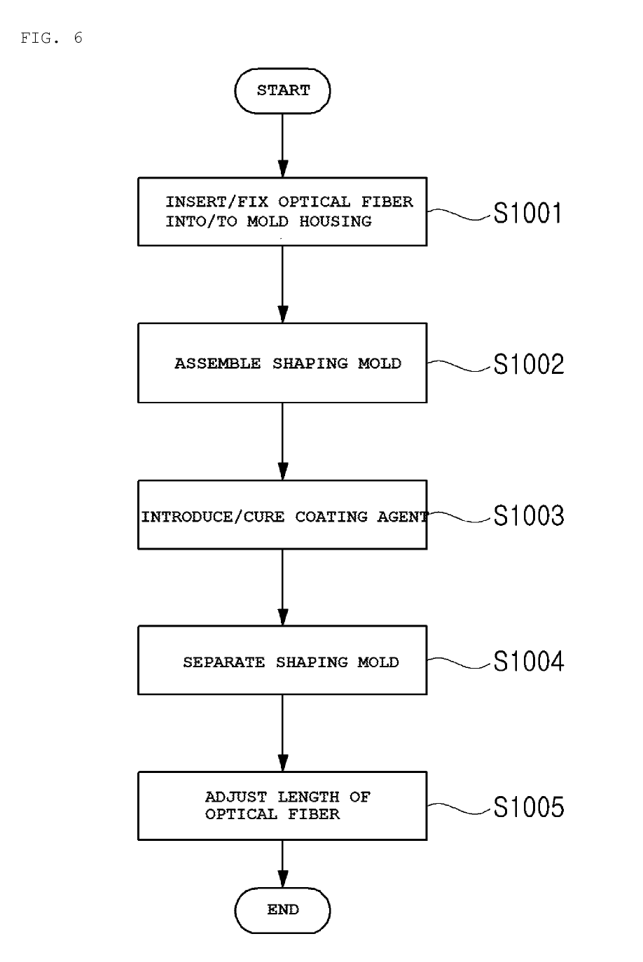

The mold housing 130 is a case into and to which the optical cable 110 and the optical fiber 120 are partially inserted and fixed, and, as illustrated in FIGS. 5A to 5C, an end portion of one side thereof has a streamlined shape. The mold housing 130 includes an optical cable accommodation groove 132 provided at a central portion of an end portion of another side thereof to accommodate the optical cable 110, and an optical fiber accommodation hole 134 extending from the optical cable accommodation groove 132 and penetrating the streamlined end portion of the mold housing 130.

In addition, the mold housing 130 includes a coating agent introduction hole 136 communicated with the optical fiber accommodation hole 134 so as to allow fluid to flow therebetween from an outer side of the mold housing 130 so that a liquid-type coating agent permeates the optical fiber accommodation hole 134 therethrough.

In addition, the mold housing 130 includes a fixing part 138 provided at an end portion of the other side of the mold housing 130, and the fixing part 138 serves to fix the optical cable 110 and the optical fiber 120. In this regard, the fixing part 130 may be provided with threads 139 so as to be screw-coupled with a separate exterior housing (not shown).

Referring back to FIG. 4, the coating layer 140 serves to protect the fiber optic sensor from external environmental factors and is formed to a certain thickness on an outer circumference and a surface of the mold housing 130. In this regard, the coating layer 140 is also formed on an outer circumference of a portion of the optical fiber inserted into the mold housing 130 and thus allows the optical fiber 120 to be stably accommodated in the mold housing 130. However, the coating layer may not be formed at a surface of the fixing part 138 of the mold housing 130.

The coating layer 140 may be formed as, for example, a platinum catalyst silicon coating layer, and the platinum catalyst silicon coating layer may be formed in a predetermined shape by mixing a platinum catalyst silicon liquid as a main solvent and a curing agent in a ratio of 50:50 and injecting the resulting mixture into a shaping mold, following by curing for 1 hour to 2 hours.

A method of manufacturing the fiber optic sensor according to an embodiment of the present invention having the above-described structure will be described as follows.

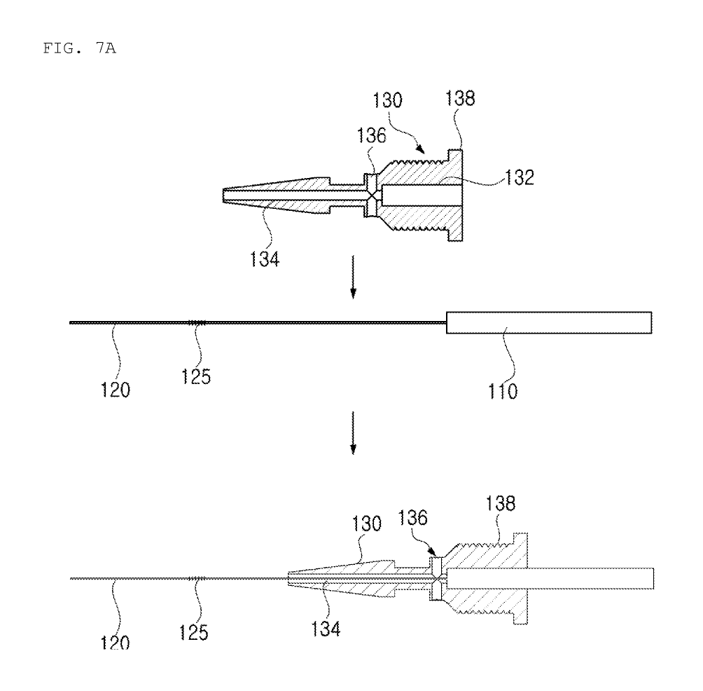

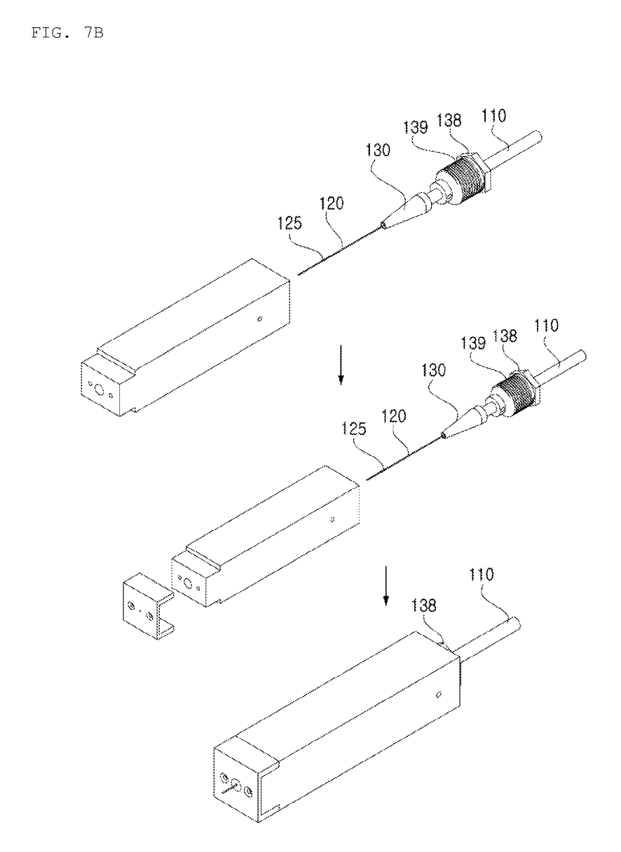

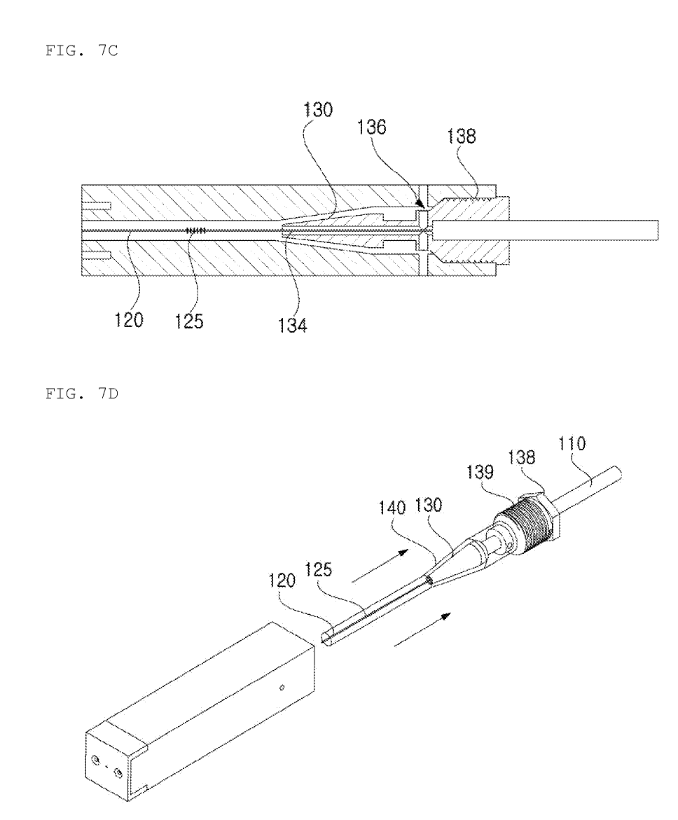

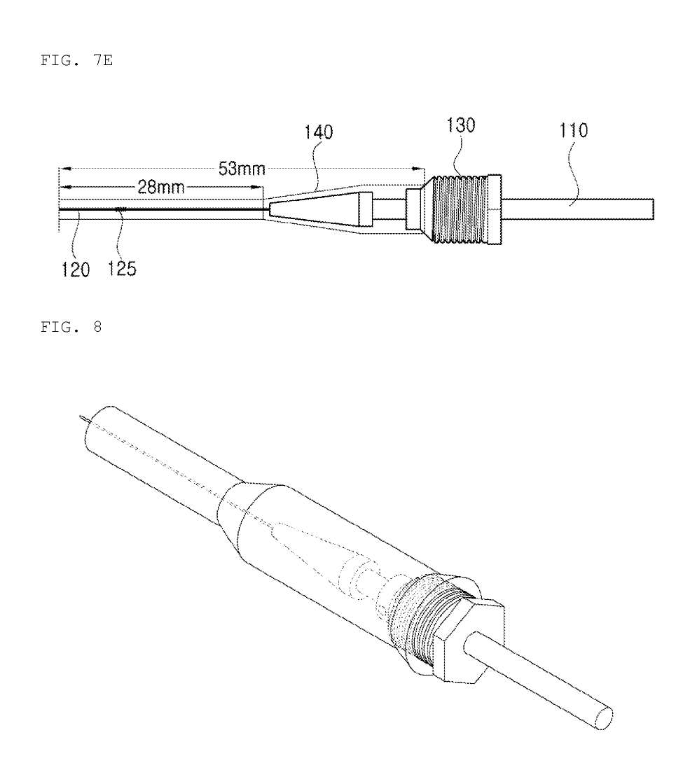

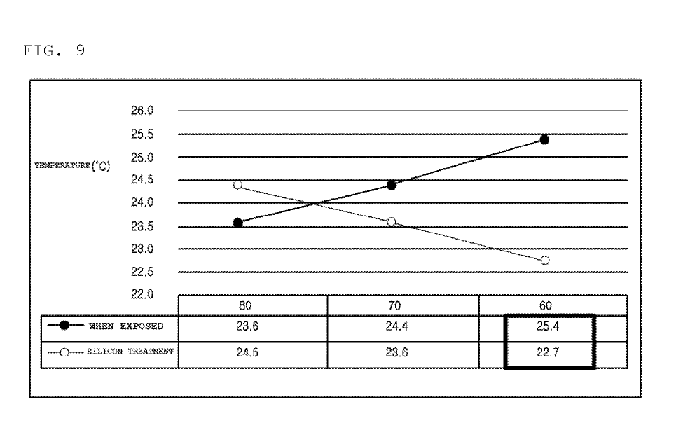

FIG. 6 is a flowchart for explaining a method of manufacturing the fiber optic sensor according to an embodiment of the present invention. FIGS. 7A to 7E are views particularly illustrating each process of FIG. 6. FIG. 8 is an actual image of a fiber optic sensor manufactured using the processes of FIG. 6 according to an embodiment of the present invention.

First, as illustrated in FIGS. 6 and 7A, the optical cable 110, out of which the optical fiber 120 is taken so as to expose the Bragg grating 125, is inserted into the mold housing 130 and fixed thereto (operation S1001). At this time, an adhesive is applied between the optical cable 110 inserted into the mold housing 130 and the optical cable accommodation groove 132 and fixed, and the fixing process is performed so as not to clog the coating agent introduction hole 136 through which a coating agent is to introduced.

Next, as illustrated in FIGS. 6 and 7B, the mold housing 130 into which the optical fiber 120 is inserted is assembled with a shaping mold (operation S1002). At this time, a central hole formed in an end portion of one side of the shaping mold is aligned so as to allow the optical fiber to pass therethrough, and, accordingly, the center of the optical fiber 120 may be maintained.

Next, as illustrated in FIGS. 6 and 7C, a coating agent is introduced via a coating agent inlet positioned at a side wall of the other side of the shaping mold and cured for a certain period of time (operation S1003). At this time, the coating agent may be, for example, a mixed solution prepared by mixing a platinum catalyst silicon solution as a main solvent and a curing agent in a ratio of 50:50, and the coating agent may be introduced using a dispenser device. At this time, as illustrated in FIG. 7C, the coating agent is introduced from the outer side of the mold housing 130 into the coating agent introduction hole 136 connected with the optical fiber accommodation hole 134 and thus the inside of the mold housing 130 is filled with the coating agent.

Next, as illustrated in FIGS. 6 and 7D, after the curing process is completed, the mold housing 130 is separated from the shaping mold (operation S1004).

Next, as illustrated in FIGS. 6 and 7E, an unnecessary portion of the optical fiber 120 is cut, thereby adjusting the length of the optical fiber 120 (operation S1005). As such, by adjusting the length of the optical fiber 120, the sensitivity of the FBG may be adjusted, and thus may be broadly applied to a variety of mechanical equipment, such as robots with high-speed and big movements, motors silently rotating in place, and the like.

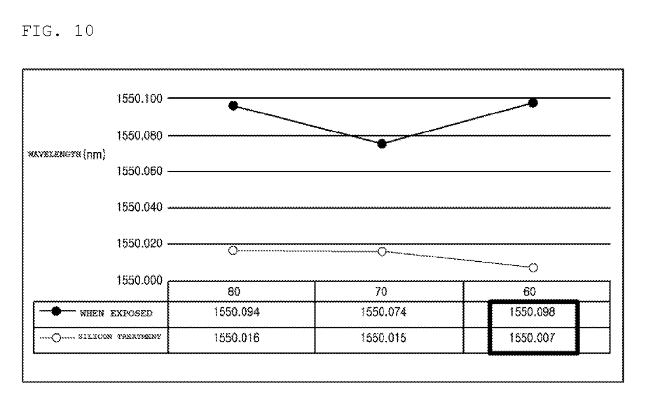

FIGS. 9 and 10 illustrate comparison results of light source setting conditions and final output signal wavelengths between a fiber optic sensor provided with a coating layer according to an embodiment of the present invention and a conventional fiber optic sensor not including a coating layer. From the drawings, it can be confirmed that the fiber optic sensor provided with a coating layer has a lower driving current and set temperature of a light source (laser diode) than those of the conventional fiber optic sensor without a coating layer.

As described above, according to the present invention, a fiber optic sensor is inserted into a mold housing and a coating layer is formed on a surface thereof, whereby structural installation limitations of mechanical equipment equipped with the fiber optic sensor or external environmental impact may be minimized, and the fiber optic sensor and the vibroscope are easily installed.

In addition, according to the present invention, a specific FBG fiber optic sensor is selectively used according to frequency band generated when inspecting vibration of mechanical equipment installed, thus enabling precise sensing.

While particular embodiments have been described in the detailed description of the present invention with reference to the accompanying drawings, the present invention should not be construed as being limited by the embodiments set forth herein and various substitutions, changes, and modifications can be made by those of ordinary skill in the art to which the present invention pertains without departing from the spirit and scope of the present invention. For example, the shape of the mold housing, the length of the optical fiber, the thickness of the coating layer, and the like may be varied.

Thus, the scope of the present invention should not be defined only by the described embodiments, but should be construed as being defined also by the following claims and equivalents thereto.

<Description of reference numerals>

| | |
|---|---|
| 10: light source | 20: circulator |
| 30: signal processing unit | 100: fiber optic sensor |
| 110: optical cable | 120: optical fiber |
| 125: Bragg grating | 130: mold housing |
| 132: optical cable accommodation | 134: optical fiber accommodation |
| groove | hole |
| 136: coating agent introduction | 138: fixing part |
| hole | |
| 140: coating layer | |

1. A fiber optic sensor comprising:
an optical cable;
an optical fiber taken out of the optical cable and provided with a fiber Bragg grating (FBG);
a mold housing as a case into or to which the optical cable and the optical fiber are partially inserted and fixed, the mold housing comprising an optical cable accommodation groove to accommodate the optical cable, an optical fiber accommodation hole extending from the optical cable accommodation groove to accommodate the optical fiber, and a coating agent introduction hole communicated with the optical fiber accommodation hole so as to allow fluid to flow therebetween from an outer side of the mold housing so that a liquid-type coating agent permeates via the optical fiber accommodation hole; and
a coating layer filling the optical fiber accommodation hole and the coating agent introduction hole and formed on an outer circumference of the optical fiber comprising the FBG and a surface of the mold housing.

2. The fiber optic sensor according to claim 1, wherein the optical fiber is provided with a single FBG to reflect a single wavelength.

3. The fiber optic sensor according to claim 1, wherein the mold housing is provided at an outer side of the optical cable accommodation groove and further comprises a fixing part having a thread.

4. A vibroscope using a fiber optic sensor comprising:
a light source to emit light with a predetermined wavelength;
a fiber optic sensor comprising an FBG, selectively reflecting light with a particular wavelength (Bragg wavelength), and transmitting all other wavelengths;
a signal processing unit to calculate, from a peak point of reflected light reflected from the fiber optic sensor and light intensity data, a wavelength of the reflected light and to calculate a variation of vibration generated from the fiber optic sensor from the calculated wavelength value and calculate a sensed vibration value therefrom; and
a circulator to supply light emitted from the light source to the optical fiber sensor and supply light reflected by the fiber optic sensor to the signal processing unit.

5. The vibroscope according to claim 4, wherein the fiber optic sensor comprises:
an optical cable;
an optical fiber taken out of the optical cable and provided with an FBG;
a mold housing as a case into or to which the optical cable and the optical fiber are partially inserted and fixed, the mold housing comprising an optical cable accommodation groove to accommodate the optical cable, an optical fiber accommodation hole extending from the optical cable accommodation groove to accommodate the optical fiber, and a coating agent introduction hole communicated with the optical fiber accommodation hole so as to allow fluid to flow therebetween from an outer side of the mold housing so that a liquid-type coating agent permeates via the optical fiber accommodation hole; and
a coating layer filling the optical fiber accommodation hole and the coating agent introduction hole and formed on an outer circumference of the optical fiber comprising the FBG and a surface of the mold housing.

6. A method of manufacturing a fiber optic sensor, the method comprising:
inserting and fixing an optical cable provided with an optical fiber taken out thereof into and to a mold housing to expose an FBG;
assembling the mold housing with the optical fiber inserted thereinto with a shaping mold by alignment so that the optical fiber penetrates a central hole positioned in an end portion of one side of the shaping mold;
introducing a coating agent via a coating agent inlet positioned at a side wall of another side of the shaping mold and curing the coating agent for a certain period of time;
separating the mold housing from the shaping mold after the curing is completed; and
adjusting a length of the optical fiber by cutting the optical fiber.

7. The method according to claim 6, wherein the coating agent comprises a material comprising a platinum catalyst and silicon.
